(19) United States
(12) Patent Application Publication
(10) Pub. No.: US 2025/0134291 A1
(43) Pub. Date: May 1, 2025

(54) CARPET

(71) Applicant: KUNSHAN YIJIA JU TEXTILE CO., LTD., Suzhou (CN)

(72) Inventors: Shunlin CAO, Suzhou (CN); Yi ZHANG, Suzhou (CN); Yuhao SUN, Suzhou (CN); Zixiang ZHAI, Suzhou (CN)

(73) Assignee: KUNSHAN YIJIA JU TEXTILE CO., LTD., Suzhou (CN)

(21) Appl. No.: 18/836,374

(22) PCT Filed: Sep. 30, 2022
(86) PCT No.: PCT/CN2022/123307

§ 371 Date: Aug. 7, 2024

(30) Foreign Application Priority Data
Feb. 22, 2022 (CN) 202220360101.X

(51) Int. Cl. A47G 27/02; B32B 5/02; B32B 5/06; B32B 5/18; B32B 5/24; B32B 5/26; B32B 7/08

(52) U.S. Cl. CPC A47G 27/0281; B32B 5/022; B32B 5/024; B32B 5/026; B32B 5/073; B32B 5/18; B32B 5/245; B32B 5/275; B32B 7/08; B32B 2255/02; B32B 2255/26; B32B 2266/025; B32B 2307/51; B32B 2307/7376; B32B 2307/744; B32B 2471/02

(57) ABSTRACT

A carpet is provided. The carpet includes a face layer, an adhesive anti-slip layer, and an extension layer provided at edges of the face layer and the adhesive anti-slip layer, where the extension layer is sewn onto the face layer and the adhesive anti-slip layer; a face extension layer is folded downwardly to wrap the adhesive anti-slip layer and adhere a bottom edge/side of the adhesive anti-slip layer; an adhesive anti-slip layer extension layer is folded upwardly to wrap the adhesive anti-slip layer and adhere the face layer; and the downwardly folded face extension layer is adhered to the upwardly folded adhesive anti-slip layer extension layer. The carpet features a stable structure and size, easy storage by a convenient method of combination, and an anti-fatigue function. The face layer is washable, which extends the service life of the carpet and achieves environmental protection and energy conservation.

### CROSS REFERENCE TO THE RELATED APPLICATIONS

This application is the national phase entry of International Application No. PCT/CN2022/123307, filed on Sep. 30, 2022, which is based upon and claims priority to Chinese Patent Application No. 202220360101.X, filed on Feb. 22, 2022, the entire contents of which are incorporated herein by reference.

### TECHNICAL FIELD

The present disclosure relates to the field of woven carpets, and in particular to a carpet.

### BACKGROUND

Carpets are floor coverings made by manually or mechanically weaving synthetic fibers or natural fibers such as cotton, linen, wool, silk, and grass. Featuring noise reduction, heat insulation, decoration and excellent heat retention property, carpets are widely used in various scenes such as homes, hotels, sports venues, exhibition halls, vehicles, ships, and airplanes.

At present, household carpets are prone to bacterial growth due to impurities falling on their surface after long-term use. Most carpets require overall cleaning, which is difficult to operate and increases the cost of living for consumers. In addition, carpets laid on the ground are prone to movement, making them unable to provide comfort and fatigue resistance and also pose certain safety hazards. Therefore, it is highly desirable to develop an anti-fatigue and comfortable carpet that is easy to install, disassemble, maintain, and clean.

Chinese patent application CN204970740U discloses a two-in-one carpet and a face and backing thereof. The two-in-one carpet is aesthetically pleasing, anti-slip, easy to clean, and practical. It includes a face layer and an anti-slip and water-repellent backing, which are combined based on a principle of physical mechanics, namely static friction. The anti-slip and water-repellent function of the backing is achieved through a foam-latex bottom, a thermoplastic elastomer (TPE) bottom, an anti-slip hot-melt adhesive bottom, or a composite point plastic bottom. The face layer can be easily separated from the backing as needed and washed by a water washing machine, and the backing can also be manually cleaned or washed by other methods. In the existing patent, the face layer can be washed in the water washing machine, but the backing cannot be washed in the water washing machine, which increases the difficulty of cleaning and maintenance, and makes it difficult to meet the needs of consumers. In addition, the face layer and the backing combined by the static friction are prone to displacement, which has certain safety hazards. And the face layer may experience uneven shrinkage after washing, thereby leading to an uneven face with a raised edge.

Therefore, there is an urgent need for a carpet that solves the problems such as unsafe use, difficult maintenance, and unsustainable comfort experience.

### SUMMARY

To solve the above technical problem, the present disclosure provides a carpet.

The objective of the present disclosure can be achieved by the following technical solution.

An embodiment of the present disclosure provides a carpet. The carpet includes a face layer, an adhesive anti-slip layer, and an extension layer, where the adhesive anti-slip layer includes an elastic layer or a buffer layer; and a bottom of the adhesive anti-slip layer is provided with an anti-slip structure;
the extension layer is located at side edges of the face layer and the adhesive anti-slip layer; the face layer and the adhesive anti-slip layer are detachably connected through the extension layer; and the extension layer includes a face extension layer and/or an adhesive anti-slip layer extension layer;
specifically, the face layer and the adhesive anti-slip layer are detachably connected through the extension layer as follows:
one end of the face extension layer is connected to the face layer; the face extension layer is folded downwardly along the side edge of the adhesive anti-slip layer and is detachably connected to a side or bottom of the adhesive anti-slip layer or the adhesive anti-slip layer extension layer so as to wrap the adhesive anti-slip layer; and alternatively,
one end of the adhesive anti-slip layer extension layer is connected to a bottom edge of the adhesive anti-slip layer; and the adhesive anti-slip layer extension layer is folded upwardly along the side edge of the adhesive anti-slip layer and is detachably adhered to the face layer or the face extension layer so as to wrap the adhesive anti-slip layer;
the detachable adhesion is implemented by one of the following means: adhesion by an accessory with a hook structure and an accessory with a loop structure, connection by a snap fastener, and adhesion by a washable adhesive sticker; and
the elastic layer includes one of a sheet-like elastic layer, a block-like elastic layer, and a layered bag filled with an elastic material; and the buffer layer includes one of a sheet-like buffer layer, a block-like buffer layer, and a layered bag filled with a buffer material; the sheet-like elastic layer includes a layer of elastic sheet or multiple layers of stacked elastic sheets; the block-like elastic layer is formed by splicing multiple block-like elastic materials together; the layered bag includes a bag body and the elastic material and/or buffer material filled inside the bag body; the filled elastic material includes one or more of a plastic particle, a natural organic/inorganic particle, and a natural organic/inorganic sheet; the filled buffer material includes one or more of gravel and an anti-fatigue medicinal powder/particle.

As an implementation of the present disclosure, the plastic particle includes one or more of a thermoplastic elastomer (TPE) particle, an ethyl vinyl acetate (EVA) particle, an ethylene-propylene-diene monomer (EPDM) particle, a cross-linked polyethylene (XPE) particle, an irradiation cross-linked polyethylene (IXPE) particle, a polyurethane (PU) particle, and a styrene butadiene rubber (SBR) particle; the sheet includes a three-dimensional (3D) mesh fabric sheet, an air fiber sheet, a needled non-woven fabric sheet, a foam elastomer sheet, as well as an elastic/buffer sheet made of a tufted, warp/weft knitted or woven fabric and having a certain thickness and density; the foam elastomer includes one or more of EVA, PU, EPDM, XPE, SBR, NBR, PVC, TPE, natural latex, and an elastic sheet prepared by a foaming process.

As an implementation of the present disclosure, specifically, the fabric with a hook structure and the fabric with a loop structure are connected as follows:
the face extension layer is provided with a fabric with a loop structure/a fabric with a hook structure; the side edge or the bottom edge of the adhesive anti-slip layer is provided with a fabric with a hook structure/a fabric with a loop structure; and the fabric with a loop structure is adhered to the fabric with a hook structure;
alternatively, the adhesive anti-slip layer extension layer is provided with a fabric with a hook structure/a fabric with a loop structure; an edge of a lower surface of the face layer is provided with a fabric with a loop structure/a fabric with a hook structure; and the fabric with a loop structure is adhered to the fabric with a hook structure; and
alternatively, the face extension layer is provided with a fabric with a single-sided/two-sided hook structure/a fabric with a loop structure; the adhesive anti-slip layer extension layer is provided with a fabric with a single-sided/two-sided loop structure/a fabric with a hook structure; and the fabric with a loop structure is adhered to the fabric with a hook structure.

As an implementation of the present disclosure, the hook structure includes one or more of a hook fabric, a hook fastener, and an injection-molded hook; the loop structure includes multiple loops on a surface of the fabric; and the loop is directly formed by a tufting, knitting, weaving, non-woven, or looping process.

As an implementation of the present disclosure, the connection by the snap fastener is as follows:
a lower surface of the face extension layer is provided with a stud/socket; the side edge or the bottom edge of the adhesive anti-slip layer is provided with a socket/stud; and the stud/socket of the extension layer faces downwardly and is correspondingly connected to the socket/stud at the side edge or the bottom edge of the adhesive anti-slip layer;
alternatively, a lower surface of the adhesive anti-slip layer extension layer is provided with a stud/socket; a bottom edge of the face layer is provided with a socket/stud; and the stud/socket of the adhesive anti-slip layer extension layer faces upwardly and is correspondingly connected to the socket/stud at the bottom edge of the face layer; and
alternatively, an upper/lower surface of the adhesive anti-slip layer extension layer is provided with a stud/socket; an upper/lower surface of the face extension layer is provided with a socket/stud; and the socket/stud on the downwardly folded face extension layer is correspondingly connected to the stud/socket on the upwardly folded adhesive anti-slip layer extension layer;

As an implementation of the present disclosure, the connection by the washable adhesive sticker is as follows:
the lower surface of the face extension layer is provided with the washable adhesive sticker, and the washable adhesive sticker is adhered to an edge portion of the side or bottom of the adhesive anti-slip layer;
alternatively, an upper/lower surface of the face extension layer is provided with the washable adhesive sticker, and the washable adhesive sticker is adhered to a connection portion of an upper/lower surface of the adhesive anti-slip layer extension layer;
alternatively, the upper/lower surface of the adhesive anti-slip layer extension layer is provided with the washable adhesive sticker, and the washable adhesive sticker is adhered to a connection portion of the upper/lower surface of the face extension layer; and
alternatively, the lower surface of the adhesive anti-slip layer extension layer is provided with the washable adhesive sticker, and the washable adhesive sticker is adhered to an edge portion of a lower surface of the face layer.

As an implementation of the present disclosure, a lower surface of the face layer is connected to an upper surface of the adhesive anti-slip layer through a fabric with a hook structure and a fabric with a loop structure or through the fabric with the hook structure and a non-woven fabric; and
alternatively, the lower surface of the face layer is adhered to the upper surface of the adhesive anti-slip layer through the washable adhesive sticker.

As an implementation of the present disclosure, the face layer includes at least one of a tufted face layer, a knitted face layer, a woven face layer, a needled face layer, a flocked face layer, a hand-woven face layer, and an artificial leather face layer, and is provided with a waterproof, oil-proof, and anti-fouling coating; and the face layer is made of a material, including a chemical fiber, a natural fiber, and a blend fiber.

As an implementation of the present disclosure, the face layer has a thickness of 1.5 mm-70 mm.

As an implementation of the present disclosure, the adhesive anti-slip layer has a thickness of not less than 3 mm.

As an implementation of the present disclosure, a bottom of the elastic layer or the bag made of fabric or film is provided with an anti-slip coating; and the anti-slip coating includes one of a TPE layer, a foam latex layer, and an anti-slip precoat.

As an implementation of the present disclosure, the snap fastener includes a stud and a socket.

As an implementation of the present disclosure, the stud and the socket of the snap fastener are correspondingly provided on the lower surface of the face extension layer and the edge of the lower surface, as well as the side, of the adhesive anti-slip layer.

As an implementation of the present disclosure, the stud and the socket of the snap fastener are correspondingly provided on the edge of the lower surface of the face layer and the lower surface of the adhesive anti-slip layer extension layer.

As an implementation of the present disclosure, the stud and the socket of the snap fastener are correspondingly provided on the upper/lower surface of the face extension layer and the upper/lower surface of the adhesive anti-slip layer extension layer.

As an implementation of the present disclosure, the adhesive anti-slip layer is further provided with a low-voltage wire or heating device. In the present disclosure, the low-voltage wire or heating device can be provided in the adhesive anti-slip layer of the carpet through secondary processing, such that the carpet has a heating function.

As an implementation of the present disclosure, the anti-slip structure forms an anti-slip bottom of the elastic layer or the buffer layer; the anti-slip bottom forms a bottom of the elastic layer or the buffer layer and is made of an anti-slip material; alternatively, an anti-slip layer is combined with the elastic layer or the buffer layer; the anti-slip structure of the layered bag forms a bottom of the bag and is made of an anti-slip fabric or plastic film; alternatively, an anti-slip coating is combined at the bottom of the bag; and the anti-slip coating includes one of a TPE layer, a foam latex layer, and an anti-slip precoat.

As an implementation of the present disclosure, the lower surface of the face layer and the upper surface of the adhesive anti-slip layer are provided with the fabric with a loop structure or the fabric with a hook structure to ensure stable connection between the face layer and the adhesive anti-slip layer.

In some embodiments, the face extension layer is connected to the adhesive anti-slip layer as follows: the fabric with a loop structure is sewn onto a border of the face layer to form the face layer extension layer; the face layer extension layer is folded downwardly to wrap the adhesive anti-slip layer; and the downwardly folded extension layer is adhered to the hook fabric on the lower surface of the adhesive anti-slip layer, such that the face layer is integrated with the adhesive anti-slip layer.

In some embodiments, the face extension layer is connected to the adhesive anti-slip layer as follows: the hook fabric is sewn at an edge of the face layer to form the face layer extension layer; the face layer extension layer is folded downwardly to wrap the adhesive anti-slip layer; the downwardly folded extension layer is adhered to the fabric with a loop structure on the lower surface of the adhesive anti-slip layer, such that the face layer is integrated with the adhesive anti-slip layer.

In some embodiments, the face extension layer is connected to the adhesive anti-slip layer as follows: the fabric with a loop structure is sewn onto a border of the face layer to form the face layer extension layer; the face layer extension layer is folded downwardly to wrap the adhesive anti-slip layer; and the downwardly folded extension layer is adhered to the hook fabric on the side of the adhesive anti-slip layer side of, such that the face layer is integrated with the adhesive anti-slip layer.

In some embodiments, the face layer and the adhesive anti-slip layer are further connected through an all-purpose adhesive sticker; the all-purpose adhesive sticker is provided on the adhesive anti-slip layer and completely covers the adhesive anti-slip layer; the all-purpose adhesive sticker is provided in a point-like pattern, a strip-like pattern, or in other patterns on the upper surface or side of the adhesive anti-slip layer; and the all-purpose adhesive sticker on a packing material of the adhesive anti-slip layer is adhered to the face layer and the face extension layer, such that the face layer is tightly and firmly adhered to the adhesive anti-slip layer.

### BRIEF DESCRIPTION OF THE DRAWINGS

Other features, objectives, and advantages of the present disclosure will become more apparent by reading the detailed description of non-limiting embodiments with reference to the following drawings.

FIG. 1 is a structural diagram of a carpet according to Embodiment 1 of the present disclosure;

FIG. 2 is a structural diagram of a carpet according to Embodiment 2 of the present disclosure;

FIG. 3 is a structural diagram of a carpet according to Embodiment 3 of the present disclosure;

FIG. 4 is a structural diagram of a carpet according to Embodiment 7 of the present disclosure;

FIG. 5 is a structural diagram of a carpet according to Embodiment 5 of the present disclosure;

FIG. 6 is a structural diagram of a carpet according to Embodiment 6 of the present disclosure;

FIG. 7 is a structural diagram of a carpet according to Embodiment 4 of the present disclosure;

FIG. 8 is a structural diagram of a carpet according to Embodiment 8 of the present disclosure;

FIG. 9 is a structural diagram of a carpet according to Embodiment 9 of the present disclosure;

FIG. 10 is a structural diagram of a carpet according to Embodiment 10 of the present disclosure; and

FIG. 11 is a structural diagram of a carpet according to Embodiment 11 of the present disclosure.

Reference Numerals: 1. face layer; 2. face extension layer; 3. adhesive anti-slip layer; 4. adhesive anti-slip layer extension layer; 5. hook structure located at lower surface of adhesive anti-slip layer; 6. loop structure located on lower surface of adhesive anti-slip layer; 7. hook structure located on side of adhesive anti-slip layer; 8. snap fastener socket located on lower surface of face extension layer; 9. snap fastener stud located on lower surface of adhesive anti-slip layer; 10. loop structure located at edge of lower surface of face layer; 11. snap fastener socket located on adhesive anti-slip layer extension layer; 12. snap fastener stud located at edge of lower surface of face layer; 13. snap fastener stud located on lower surface of face extension layer; 14. washable adhesive sticker; and 15. loop structure located on side of adhesive anti-slip layer.

### DETAILED DESCRIPTION OF THE EMBODIMENTS

The present disclosure will be described in detail below with reference to the drawings and specific embodiments. The following examples are implemented under the premise of the technical solution of the present disclosure. The present disclosure provides detailed implementations and specific operating procedures, which will help those skilled in the art to further understand the present disclosure. It should be pointed out that the protection scope of the present disclosure is not limited to the following embodiments. Therefore, adjustments and improvements made to the present disclosure fall within the protection scope of the present disclosure.

The present disclosure is described in detail below with reference to the embodiments. The following embodiments will help those skilled in the art to further understand the present disclosure, but do not limit the present disclosure in any way. It should be noted that those of ordinary skill in the art can further make adjustments and improvements without departing from the concept of the present disclosure, and all of these fall within the protection scope of the present disclosure.

An embodiment of the present disclosure provides a carpet. The carpet includes a face layer, an adhesive anti-slip layer, and an extension layer. The face layer includes a napped surface made of chemical fibers, natural fibers, or blend fibers through various weaving processes such as tufting, knitting, weaving, needling, flocking, and hand weaving. The adhesive anti-slip layer has an anti-fatigue function, and is specifically an independent structure prepared by externally packing a foam elastomer, sand, a wheat husk, and an anti-fatigue health-protective medicinal material. An external packing material includes an upper surface with a hook fabric. The upper surface of the external packing material is a loop structure or a non-woven material, or the external packing material is a smooth, waterproof, and breathable material. The adhesive anti-slip layer has an anti-slip function and is prepared by combining a woven, knitted, or non-woven material with an anti-slip treatment layer. The anti-slip treatment layer includes a thermoplastic elastomer (TPE), foam latex, or an anti-slip fabric or material.

In this embodiment, a fabric or hook fabric with a loop structure is sewn at an edge of the face layer or the adhesive anti-slip layer to form the extension layer. The face extension layer is folded downwardly to wrap the adhesive anti-slip layer and adhere the adhesive anti-slip layer. The design achieves stable structure and size, ensuring safe use. In addition, by utilizing the anti-fatigue function of the adhesive anti-slip layer, the design greatly enhances the user experience and expands the range and scenarios of carpet use.

In this embodiment, the anti-slip layer of the carpet provides an anti-slip function, and the anti-slip treatment layer is a structural layer prepared by combining a woven, knitted, or non-woven material with hot-melt adhesive, TPE, and foam latex, or a structural layer formed by an anti-slip fabric and/or material. By adding various anti-slip materials or fabrics to the anti-slip layer, the carpet has a strong anti-slip function and improves usage safety.

The carpet provided by the present disclosure is described below according to several specific application examples.

### Embodiment 1

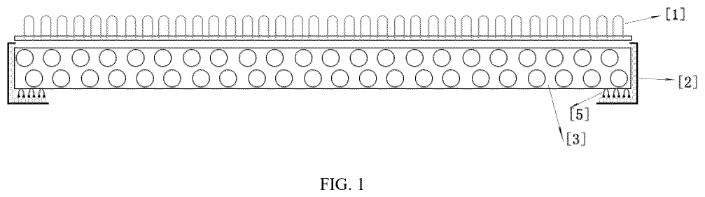

This embodiment provides a carpet. As shown in FIG. 1, the carpet includes face layer 1, face extension layer 2, adhesive anti-slip layer 3, and hook structure 5 located on a lower surface of the adhesive anti-slip layer.

The carpet is prepared as follows:

S1. The face layer and the face extension layer are prepared. A woven fabric is used. The face layer is prepared by combining a 120 gsm looping woven fabric with thermoplastic polyurethane (TPU) hot-melt adhesive. The 120 gsm looping woven fabric is sewn onto a border of the face layer to form the face extension layer.

S2. The adhesive anti-slip layer is prepared. A 100 gsm non-woven fabric and a 25 mm thick 30 D sponge are used. The sponge is packed with the non-woven fabric to form the adhesive anti-slip layer with an anti-fatigue function. 1135B hot-melt adhesive is roll-coated onto a lower surface of the packing material of the adhesive anti-slip layer, with a dry adhesive content of 40 gsm. 2 cm wide hook fasteners are sewn in a strip pattern at an edge of the lower surface of the adhesive anti-slip layer.

S3. Combination. The various structural layers prepared by the steps S1 and S2 are combined. Specifically, the face extension layer prepared by the step S1 is folded downwardly to wrap the adhesive anti-slip layer prepared by the step S2. The hook fasteners at the edge of the lower surface of the adhesive anti-slip layer prepared by the step S2 are adhered to the face extension layer prepared by the step S1. Through overall combination, the carpet is formed.

### Embodiment 2

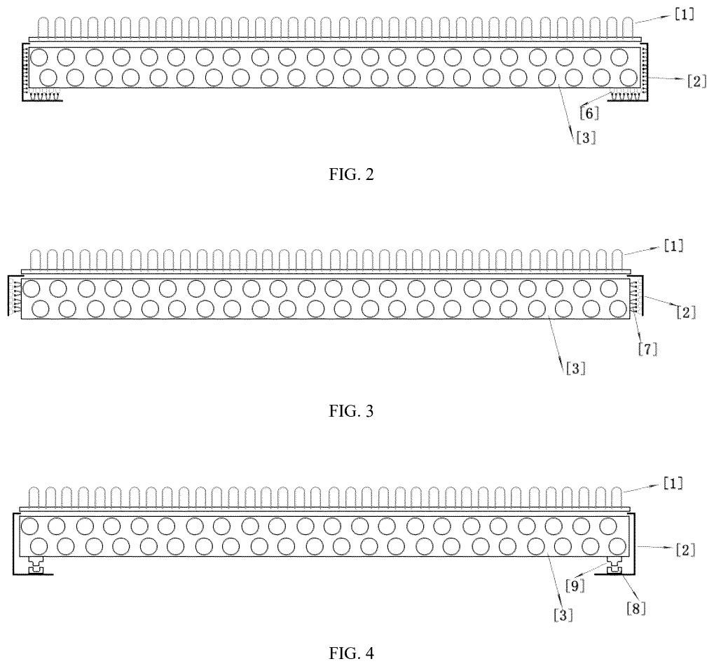

This embodiment provides a carpet. As shown in FIG. 2, the carpet includes face layer 1, face extension layer 2, adhesive anti-slip layer 3, and loop structure 6 located on a lower surface of the adhesive anti-slip layer.

The carpet is prepared as follows:

S1. The face layer and the face extension layer are prepared. A tufted fabric is used. A 100 gsm non-woven fabric is combined with TPU hot-melt adhesive to form the face layer. An edge of the face layer is covered with a 48 mm wide woven fabric. A 130 gsm hook fabric is sewn onto a border of the face layer to form the face extension layer.

S2. The adhesive anti-slip layer is prepared. A 100 gsm non-woven fabric and a 40 mm thick 30 D sponge are used. The sponge is packed with the non-woven fabric, which serves as upper and lower surfaces of a packing material, to form the adhesive anti-slip layer with an anti-fatigue function. 1135B hot-melt adhesive is roll-coated onto a lower surface of the packing material of the adhesive anti-slip layer, with a dry adhesive content of 40 gsm. A 2 cm wide looping woven fabric is sewn in a strip pattern at an edge of the lower surface of the adhesive anti-slip layer.

S3. Combination. The various structural layers prepared by the steps S1 and S2 are combined. Specifically, the face extension layer prepared by the step S1 is folded downwardly to wrap the adhesive anti-slip layer prepared by the step S2. The looping woven fabric at the edge of the lower surface of the adhesive anti-slip layer prepared by the step S2 is adhered to the face extension layer prepared by the step S1. Through overall combination, the carpet is formed.

### Embodiment 3

This embodiment provides a carpet. As shown in FIG. 3, the carpet includes face layer 1, face extension layer 2, adhesive anti-slip layer 3, and hook structure 7 located on a side of the adhesive anti-slip layer.

The carpet is prepared as follows:

S1. The face layer and the face extension layer are prepared. A tufted fabric is used. The face layer is prepared by combining a 120 gsm looping woven fabric with TPU hot-melt adhesive. The 120 gsm looping woven fabric is sewn onto a border of the face layer to form the face extension layer.

S2. The adhesive anti-slip layer is prepared. A 100 gsm non-woven fabric and a 40 mm thick 30 D sponge are used. The sponge is packed with the non-woven fabric to form the adhesive anti-slip layer with an anti-fatigue function. 1135B hot-melt adhesive is roll-coated onto a lower surface of the packing material of the adhesive anti-slip layer, with a dry adhesive content of 35 gsm. 2 cm wide hook fasteners are sewn in a strip pattern on a side of the adhesive anti-slip layer.

S3. Combination. The various structural layers prepared by the steps S1 and S2 are combined. Specifically, the face extension layer prepared by the step S1 is folded downwardly to a side of the adhesive anti-slip layer prepared by the step S2. The hook fasteners on the side of the adhesive anti-slip layer prepared by the step S2 are adhered to the face extension layer prepared by the step S1. Through overall combination, the carpet is formed.

### Embodiment 4

This embodiment provides a carpet. As shown in FIG. 7, the carpet includes face layer 1, face extension layer 2, adhesive anti-slip layer 3, and adhesive anti-slip layer extension layer 4.

The carpet is prepared as follows:

S1. The face layer and the face extension layer are prepared. A knitted fabric is used. The face layer is prepared by combining a 100 gsm woven fabric with TPU hot-melt adhesive. A 130 gsm hook fabric is sewn onto a border of the face layer to form the face extension layer.

S2. The adhesive anti-slip layer and the adhesive anti-slip layer extension layer are prepared. A 100 gsm non-woven fabric is combined on an upper surface of 25 mm thick 30 D cross-linked polyethylene (XPE), and KBT-FB003 TPE is combined on a lower surface of the XPE, with an adhesive content of 500 gsm. A 120 gsm looping woven-fabric is sewn at an edge of the lower surface of the XPE. In this way, the adhesive anti-slip layer and the adhesive anti-slip layer extension layer with an anti-fatigue function are formed.

S3. Combination. The various structural layers prepared by the steps S1 and S2 are combined. Specifically, the adhesive anti-slip layer extension layer prepared by the step S2 is folded upwardly to a side of the adhesive anti-slip layer and adheres to the face extension layer prepared by the step S1. Through overall combination, the carpet is formed.

### Embodiment 5

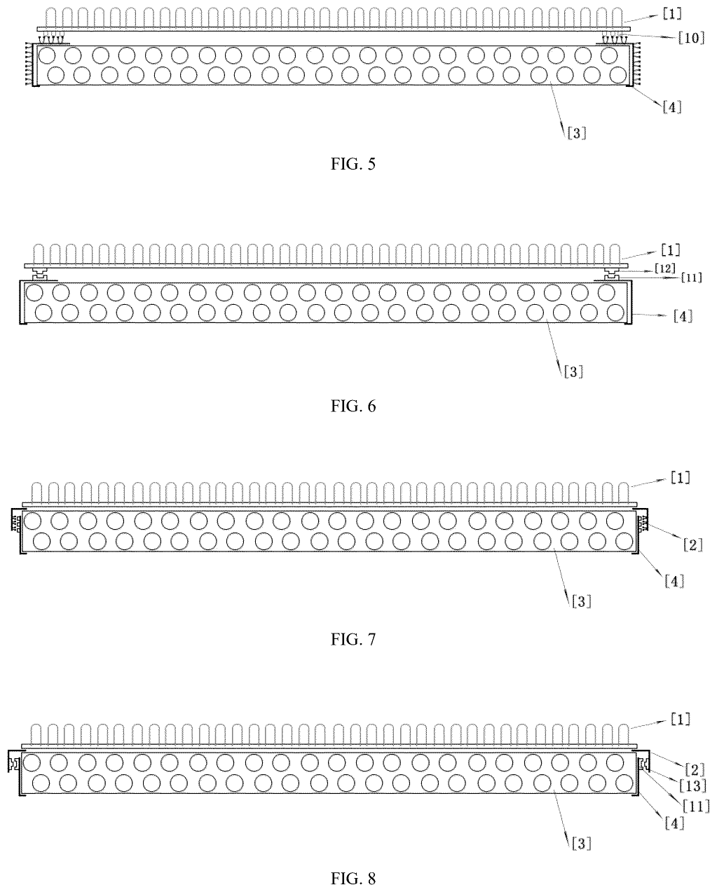

This embodiment provides a carpet. As shown in FIG. 5, the carpet includes face layer 1, adhesive anti-slip layer extension layer 4, adhesive anti-slip layer 3, and loop structure 10 located at an edge of a lower surface of the face layer.

The carpet is prepared as follows:

S1. The face layer is prepared. A tufted fabric is used. A 100 gsm non-woven fabric is combined with KBT-FG003 TPE. A 2 cm looping woven fabric is sewn in a strip pattern at an edge of the lower surface of the face layer. In this way, the face layer is formed.

S2. The adhesive anti-slip layer and the extension layer are prepared. A 100 gsm non-woven fabric is combined on an upper surface of a 1,000 gsm, 25 mm thick sandwich, and a 100 gsm non-woven fabric is combined on a lower surface of the sandwich. 1135B hot-melt adhesive is roll-coated onto the non-woven fabric, with a dry adhesive content of 40 gsm. A 130 gsm hook fabric is sewn at an edge of the lower surface of the sandwich with the non-woven fabric as the adhesive anti-slip layer extension layer. In this way, the adhesive anti-slip layer with an anti-fatigue function is formed.

S3. Combination. The various structural layers prepared by the steps S1 and S2 are combined. Specifically, the adhesive anti-slip layer extension layer prepared by the step S2 is folded upwardly to wrap the adhesive anti-slip layer prepared by the step S2. The looping woven fabric at the edge of the lower surface of the face layer prepared by the step S1 is adhered. Through overall combination, the carpet is formed.

### Embodiment 6

This embodiment provides a carpet. As shown in FIG. 6, the carpet includes face layer 1, adhesive anti-slip layer extension layer 4, adhesive anti-slip layer 3, snap fastener sockets 11 located on the adhesive anti-slip layer extension layer, and snap fastener studs 12 located at an edge of a lower surface of the face layer.

The carpet is prepared as follows:

S1. The face layer is prepared. A knitted fabric is used. A 100 gsm non-woven fabric is combined with KBT-FG003 TPE to form the face layer. The snap fastener studs are arranged in a dotted pattern at the edge of the lower surface of the face layer.

S2. The adhesive anti-slip layer and the extension layer are prepared. A 100 gsm non-woven fabric is combined on an upper surface of an 800 gsm, 20 mm thick sandwich, and a 100 gsm non-woven fabric is combined on a lower surface of the sandwich. 1135B hot-melt adhesive is roll-coated onto the non-woven fabric, with a dry adhesive content of 40 gsm. A 100 gsm woven fabric is sewn at an edge of the lower surface of the sandwich with the non-woven fabric as the adhesive anti-slip layer extension layer. The snap fastener sockets are arranged in a dotted pattern at an edge of the adhesive anti-slip layer extension layer. In this way, the adhesive anti-slip layer with an anti-fatigue function is formed.

S3. Combination. The various structural layers prepared by the steps S1 and S2 are combined. Specifically, the adhesive anti-slip layer extension layer prepared by the step S2 is folded upwardly to wrap the adhesive anti-slip layer prepared by the step S2. The snap fastener sockets at the edge of the adhesive anti-slip layer are engaged with the snap fastener studs at the edge of the lower surface of the face layer prepared by the step S1. Through overall combination, the carpet is formed.

### Embodiment 7

This embodiment provides a carpet. As shown in FIG. 4, the carpet includes face layer 1, face extension layer 2, adhesive anti-slip layer 3, snap fastener sockets 8 located on a lower surface of the face extension layer, and snap fastener studs 9 located on a lower surface of an adhesive anti-slip layer extension layer.

The carpet is prepared as follows:

S1. The face layer and the face extension layer are prepared. A tufted fabric is used. A 100 gsm woven fabric is combined with TPU hot-melt adhesive to form the face layer, and an edge of the face layer is covered with a 48 mm woven fabric. A 100 gsm woven fabric is sewn at a border of the face layer to form the face extension layer. The snap fastener sockets are arranged in a dotted pattern on the lower surface of the face extension layer.

S2. The adhesive anti-slip layer is prepared. A 100 gsm non-woven fabric and a 40 mm thick 30 D sponge are used. The non-woven fabric serves as upper and lower surfaces of a packing material to pack the sponge to form the adhesive anti-slip layer with an anti-fatigue function. 1135B hot-melt adhesive is roll-coated onto the lower surface of the packing material of the adhesive anti-slip layer, with a dry adhesive content of 40 gsm. The snap fastener studs are arranged in a dotted pattern at an edge of a lower surface of the adhesive anti-slip layer.

S3. Combination. The various structural layers prepared by the steps S1 and S2 are combined. Specifically, the face extension layer prepared by the step S1 is folded downwardly to wrap the adhesive anti-slip layer prepared by the step S2. The snap fastener studs located at the edge of the lower surface of the adhesive anti-slip layer prepared by the step S2 are engaged with the snap fastener sockets located on the lower surface of the face extension layer prepared by the step S1. Through overall combination, the carpet is formed.

### Embodiment 8

This embodiment provides a carpet. As shown in FIG. 7, the carpet includes face layer 1, face extension layer 2, adhesive anti-slip layer 3, adhesive anti-slip layer extension layer 4, snap fastener sockets located on the adhesive anti-slip layer extension layer, and snap fastener studs located on a lower surface of the face extension layer.

The carpet is prepared as follows:

S1. The face layer and the face extension layer are prepared. A tufted fabric is used. A 100 gsm non-woven fabric is combined with TPU hot-melt adhesive to form the face layer. A 100 gsm woven fabric is sewn at a border of the face layer. The snap fastener studs are arranged on a lower surface of the woven fabric. In this way, the face layer and the face extension layer are formed.

S2. The adhesive anti-slip layer and the adhesive anti-slip layer extension layer are prepared. A 100 gsm non-woven fabric is combined on an upper surface of 25 mm thick 30 D sponge, and KBT-FB005 TPE is combined on a lower surface of the sponge, with an adhesive content of 420 gsm. A 100 gsm woven fabric is sewn at an edge of the lower surface of the sponge. The snap fastener sockets are arranged on a lower surface of the woven fabric. In this way, the adhesive anti-slip layer and the adhesive anti-slip layer extension layer with an anti-fatigue function are formed.

S3. Combination. The various structural layers prepared by the steps S1 and S2 are combined. Specifically, the adhesive anti-slip layer extension layer prepared by the step S2 is folded upwardly to a side of the adhesive anti-slip layer. The snap fastener sockets on the adhesive anti-slip layer extension layer are engaged with the snap fastener studs on the face extension layer prepared by the step S1. Through overall combination, the carpet is formed.

### Embodiment 9

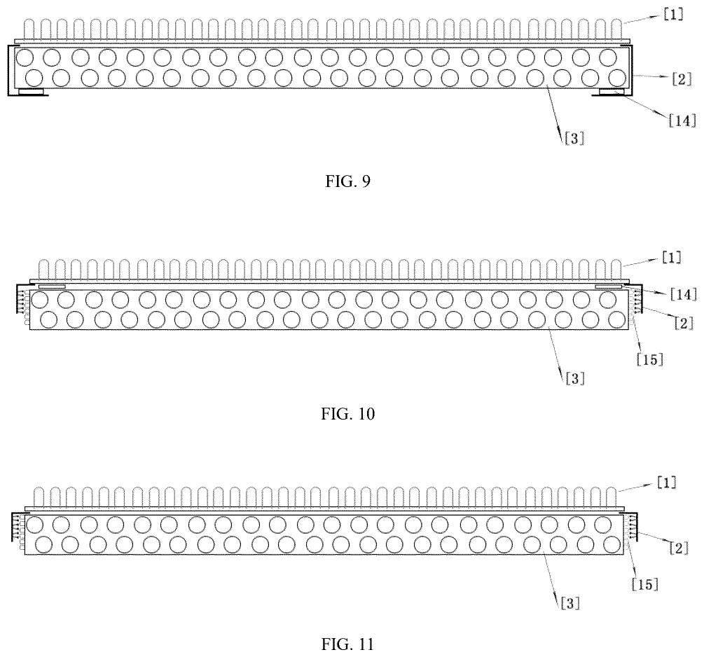

This embodiment provides a carpet. As shown in FIG. 9, the carpet includes face layer 1, face extension layer 2, adhesive anti-slip layer 3, and washable adhesive sticker 14.

The carpet is prepared as follows:

S1. The face layer and the face extension layer are prepared. A tufted fabric is used. A 100 gsm non-woven fabric is combined with TPU hot-melt adhesive to form the face layer. A 100 gsm woven fabric is sewn onto a border of the face layer. The washable adhesive sticker with a width of 2 cm is arranged in a strip pattern on a lower surface of the woven fabric. In this way, the face layer and the face extension layer are formed.

S2. The adhesive anti-slip layer is prepared. A 100 gsm woven fabric and a 40 mm thick 30 D sponge are used. The woven fabric serves as upper and lower surfaces of a packing material to pack the sponge to form the adhesive anti-slip layer with an anti-fatigue function. 1135B hot-melt adhesive is roll-coated onto a lower surface of the packing material of the adhesive anti-slip layer, with a dry adhesive content of 40 gsm.

S3. Combination. The various structural layers prepared by the steps S1 and S2 are combined. Specifically, the face extension layer prepared by the step S1 is folded downwardly to wrap the adhesive anti-slip layer prepared by the step S2. The woven fabric at the edge of the lower surface of the adhesive anti-slip layer prepared by the step S2 is adhered to the washable adhesive sticker on the face extension layer prepared by the step S1. Through overall combination, the carpet is formed.

### Embodiment 10

This embodiment provides a carpet. As shown in FIG. 10, the carpet includes face layer 1, face extension layer 2, adhesive anti-slip layer 3, and washable adhesive sticker 14.

The carpet is prepared as follows:

S1. The face layer and the face extension layer are prepared. A tufted fabric is used. A 100 gsm non-woven fabric is combined with TPU hot-melt adhesive to form the face layer. A 130 gsm hook fabric is sewn onto a border of the face layer. In this way, the face layer and the face extension layer are formed.

S2. The adhesive anti-slip layer is prepared. A 120 gsm looping woven fabric and a 40 mm thick 30 D sponge are used. The 120 gsm looping woven fabric is combined on upper and lower surfaces as well as a side of the sponge to form the adhesive anti-slip layer with an anti-fatigue function. The adhesive sticker, 2 cm wide and 10 cm long, is applied at an edge of an upper surface of the adhesive anti-slip layer. 1135B hot-melt adhesive is roll-coated onto a lower surface of the adhesive anti-slip layer, with a dry adhesive content of 40 gsm

S3. Combination. The various structural layers prepared by the steps S1 and S2 are combined. Specifically, the face extension layer prepared by the step S1 is folded downwardly to a side of the adhesive anti-slip layer prepared by the step S2. The non-woven fabric on the lower surface of the face layer prepared by the step S1 is adhered to the adhesive sticker at the edge of the upper surface of the adhesive anti-slip layer prepared by the step S2. Through overall combination, the carpet is formed.

### Embodiment 11

This embodiment provides a carpet. As shown in FIG. 11, the carpet includes face layer 1, face extension layer 2, adhesive anti-slip layer 3, and loop structure 15 located on a side of the adhesive anti-slip layer.

The carpet is prepared as follows:

S1. The face layer and the face extension layer are prepared. A tufted fabric is used. A 100 gsm non-woven fabric is combined with TPU hot-melt adhesive to form the face layer. A 130 gsm hook fabric is sewn onto a border of the face layer to form the face extension layer.

S2. The adhesive anti-slip layer is prepared. A 100 gsm non-woven fabric and a 40 mm thick 30 D sponge are used. The sponge is packed with the non-woven fabric to form the adhesive anti-slip layer with an anti-fatigue function. A 3 cm wide looping woven fabric is sewn onto a side of the adhesive anti-slip layer. 1135B hot-melt adhesive is roll-coated onto the non-woven fabric on a lower surface of the adhesive anti-slip layer, with a dry adhesive content of 35 gsm. In this way, the adhesive anti-slip layer is formed.

S3. Combination. The various structural layers prepared by the steps S1 and S2 are combined. Specifically, the face extension layer prepared by the step S1 is folded downwardly to a side of the adhesive anti-slip layer prepared by the step S2. The looping woven fabric on the side of the adhesive anti-slip layer prepared by the step S2 is adhered to the face extension layer prepared by the step S1. Through overall combination, the carpet is formed.

### Performance Testing

### 1. Comparative Test of Surface Flatness

Test method: A piece of two-in-one carpet proposed in Chinese patent application CN204970740U and a piece of carpet prepared by the present disclosure were taken. The comparative test objects had the same size and consistent thickness. They were subjected to a treading test by the same treader to avoid testing errors due to differences in weight and contact surface. After the test objects were treaded, changes in the carpet surface flatness were measured. In terms of the data acquisition method, height differences between highest and lowest points of the carpet face from a ground after treading were measured.

The two-in-one carpet proposed in Chinese patent application CN204970740U had a size of 50×80 cm and an overall thickness of 4 cm, which was a distance from the upper surface of the face layer to the lower surface of the anti-slip layer.

The carpet prepared by the present disclosure was one prepared by Embodiment 1 of the present disclosure, with a size of 50×80 cm and a thickness of 4 cm.

Height difference data after treading 5 times:

Height difference of the carpet face of the two-in-one carpet: 6 mm; and

Height difference of the carpet face of the carpet prepared by the present disclosure: 5 mm.

Height difference data after treading 10 times:

Height difference of the carpet face of the two-in-one carpet: 9 mm; and

Height difference of the carpet face of the carpet prepared by the present disclosure: 6 mm.

Height difference data after treading 20 times:

Height difference of the carpet face of the two-in-one carpet: 11 mm; and

Height difference of the carpet face of the carpet prepared by the present disclosure: 7 mm.

In summary, due to insufficient rebound, the surface flatness of the two-in-one carpet fluctuates greatly after being treaded. In the present disclosure, due to the close connection between the contact surfaces of each structural layer, the carpet face can still maintain good flatness even after being treaded, making it safer to use.

### 2. Comparative Test of Durability

Test method: An ordinary anti-fatigue polyurethane (PU) mat available on the market and a carpet prepared by the present disclosure were taken for a carpet face scratch friction test to simulate foot rubbing effects on the carpet face. The durability of the test objects was determined by comparing the integrity of the carpet face after the friction test.

3 pieces of anti-fatigue PU mats available on the market were selected, with a size of 40×60 cm. 3 pieces of carpets prepared by Embodiment 2 of the present disclosure were selected, with a size of 40×60 cm. The friction tests were conducted on the two types of comparison samples by a friction tester for 20, 50, and 100 times. The test results are as follows:

<1. Integrity of the Carpet Face after 20 Rubs:

Face integrity of the anti-fatigue PU mat: intact; and

Face integrity of the carpet prepared by Embodiment 2: intact.

<2. Integrity of the Carpet Face after 50 Rubs:

Face integrity of the anti-fatigue PU mat: 2 wear-outs; and

Face integrity of the carpet prepared by Embodiment 2: intact.

<3. Integrity of the Carpet Face after 100 Rubs:

Face integrity of the anti-fatigue PU mat: 8 wear-outs; and

Face integrity of the carpet prepared by Embodiment 2: intact.

In summary, in the present disclosure, the carpet face can use various materials and weaving methods. In the present disclosure, due to the special adhesion method in construction, small displacement was generated around the force point during the treading process, buffering the pressure caused by the treading. Therefore, the carpet prepared by the present disclosure has higher wear resistance and a longer service life than the ordinary anti-fatigue PU mat on the market.

### 3. Comparative Test of Water Absorption

Test method: An ordinary sponge mat available on the market and a carpet prepared by the present disclosure were taken. Water was injected into the carpet face, and then the test objects were put into a washing machine for equal-time dehydration. The weight changes of the test objects after water injection were compared to determine the water absorption performance of the test objects, thereby determining whether they were easy to maintain.

2 pieces of ordinary sponge mats available on the market were selected, with a size of 40×60 cm. 2 pieces of carpets prepared by Embodiment 1 of the present disclosure were selected, with a size of 40×60 cm. The carpet faces of the two types of comparison samples were injected with 200 ml, 500 ml, and 800 ml of water, and dehydrated for 1 min. The test results are as follows:

1. Weight Changes after Adding 200 ml of Water:

Weight change of the ordinary sponge mat: 85 g weight increase; and

Weight change of the combined anti-fatigue carpet prepared by Embodiment 1: 38 g weight increase.

2. Weight Changes after Adding 500 ml of Water:

Weight change of the ordinary sponge mat: 172 g weight increase; and

Weight change of the combined anti-fatigue carpet prepared by Embodiment 1: 84 g weight increase.

3. Weight Changes after Adding 800 ml of Water:

Weight change of the ordinary sponge mat: 370 g weight increase; and

Weight change of the combined anti-fatigue carpet prepared by Embodiment 1: 182 g weight increase.

### Anti-Fatigue Test:

In summary, it can be seen from the test data that the weight change of the combined anti-fatigue carpet of the present disclosure is relatively small. In Embodiment 1 of the present disclosure, the adhesive anti-slip layer of the combined anti-fatigue carpet uses a packing material, making it absorb less water, easy to clean and maintain, and easy to dry.

Compared with the prior art, the present disclosure has the following beneficial effects:

1. The combination method of the carpet prepared by the present disclosure is diverse and convenient for storage and organization. Especially for a carpet with a large area, the side wrapping method makes it easy to replace the carpet face, without the need to flip the adhesive anti-slip layer, thereby achieving convenient disassembly.

2. The adhesive anti-slip layer is an independent structure, which is detachable, freely combined, and easy to maintain.

3. The structural layers are adhered to each other and wrapped in different ways, making the carpet easy to disassemble, clean, and assemble. In addition, the multi-layer structure will not shrink after washing, thereby avoiding overall wrinkles.

4. The present disclosure achieves high structural and dimensional stability, as well as high surface flatness. None of the connection methods can cause wrinkles due to size changes, ensuring overall flatness and safe use.

The specific embodiments of the present disclosure are described above. It should be understood that the present disclosure is not limited to the above specific implementations, and a person skilled in the art can make various variations or modifications within the scope of the claims without affecting the essence of the present disclosure.

What is claimed is:

1. A carpet, comprising a face layer, an adhesive anti-slip layer, and an extension layer, wherein the adhesive anti-slip layer comprises an elastic layer or a buffer layer; and a bottom of the adhesive anti-slip layer is provided with an anti-slip structure;
the extension layer is located at side edges of the face layer and the adhesive anti-slip layer; the face layer and the adhesive anti-slip layer are detachably connected through the extension layer; and the extension layer comprises a face extension layer and/or an adhesive anti-slip layer extension layer;
wherein the face layer and the adhesive anti-slip layer are detachably connected through the extension layer as follows:
_an end of the face extension layer is connected to the face layer; the face extension layer is folded downwardly along the side edge of the adhesive anti-slip layer, and the face extension layer is detachably connected to a side or bottom of the adhesive anti-slip layer or the adhesive anti-slip layer extension layer so as to wrap the adhesive anti-slip layer; and alternatively,
an end of the adhesive anti-slip layer extension layer is connected to a bottom edge of the adhesive anti-slip layer; and the adhesive anti-slip layer extension layer is folded upwardly along the side edge of the adhesive anti-slip layer, and the adhesive anti-slip layer extension layer is detachably adhered to the face layer or the face extension layer so as to wrap the adhesive anti-slip layer; and
a detachable adhesion is implemented by one of the following means: an adhesion by an accessory with a hook structure and an accessory with a loop structure, a connection by a snap fastener, and an adhesion by a washable adhesive sticker.

2. The carpet according to claim 1, wherein the elastic layer comprises one of a sheet-like elastic layer, a block-like elastic layer, and a layered bag filled with an elastic material; and the buffer layer comprises one of a sheet-like buffer layer, a block-like buffer layer, and a layered bag filled with a buffer material.

3. The carpet according to claim 1, wherein the adhesion by the accessory with the hook structure and the accessory with the loop structure is implemented as follows:
the face extension layer is provided with a fabric with the loop structure/a fabric with the hook structure; the side edge or the bottom edge of the adhesive anti-slip layer is provided with the fabric with the hook structure/the fabric with the loop structure; and the fabric with the loop structure is adhered to the fabric with the hook structure;
alternatively, the adhesive anti-slip layer extension layer is provided with the fabric with the hook structure/the fabric with the loop structure; an edge of a lower surface of the face layer is provided with the fabric with the loop structure/the fabric with the hook structure; and the fabric with the loop structure is adhered to the fabric with the hook structure; and
alternatively, the face extension layer is provided with a fabric with a single-sided/two-sided hook structure/the fabric with the loop structure; the adhesive anti-slip layer extension layer is provided with the fabric with the single-sided/two-sided loop structure/the fabric with the hook structure; and the fabric with the loop structure is adhered to the fabric with the hook structure.

4. The carpet according to claim 1, wherein the hook structure comprises one or more of a hook fabric, a hook fastener, and an injection-molded hook.

5. The carpet according to claim 1, wherein the connection by the snap fastener is implemented as follows:
a lower surface of the face extension layer is provided with a stud/socket; the side edge or the bottom edge of the adhesive anti-slip layer is provided with a socket/stud; and the stud/socket of the extension layer faces downwardly and is connected to the socket/stud at the side edge or the bottom edge of the adhesive anti-slip layer;
alternatively, a lower surface of the adhesive anti-slip layer extension layer is provided with the stud/socket; a bottom edge of the face layer is provided with the socket/stud; and the stud/socket of the adhesive anti-slip layer extension layer faces upwardly and is connected to the socket/stud at the bottom edge of the face layer; and
alternatively, an upper/lower surface of the adhesive anti-slip layer extension layer is provided with the stud/socket; an upper/lower surface of the face extension layer is provided with the socket/stud; and the socket/stud on the face extension layer folded downwardly is connected to the stud/socket on the adhesive anti-slip layer extension layer folded upwardly.

6. The carpet according to claim 1, wherein the adhesion by the washable adhesive sticker is implemented as follows:
a lower surface of the face extension layer is provided with the washable adhesive sticker, and the washable adhesive sticker is adhered to an edge portion of the side or bottom of the adhesive anti-slip layer;
alternatively, an upper/lower surface of the face extension layer is provided with the washable adhesive sticker, and the washable adhesive sticker is adhered to a connection portion of an upper/lower surface of the adhesive anti-slip layer extension layer;
alternatively, the upper/lower surface of the adhesive anti-slip layer extension layer is provided with the washable adhesive sticker, and the washable adhesive sticker is adhered to a connection portion of the upper/lower surface of the face extension layer; and
alternatively, the lower surface of the adhesive anti-slip layer extension layer is provided with the washable adhesive sticker, and the washable adhesive sticker is adhered to an edge portion of a lower surface of the face layer.

7. The carpet according to claim 1, wherein a lower surface of the face layer is connected to an upper surface of the adhesive anti-slip layer through a fabric with the hook structure and a fabric with the loop structure or through the fabric with the hook structure and a non-woven fabric; and
alternatively, the lower surface of the face layer is adhered to the upper surface of the adhesive anti-slip layer through the washable adhesive sticker.

8. The carpet according to claim 1, wherein the face layer comprises one of a tufted face layer, a knitted face layer, a woven face layer, a needled face layer, a flocked face layer, a hand-woven face layer, and an artificial leather face layer.

9. The carpet according to claim 1, wherein the face layer has a thickness of 1.5 mm-70 mm.

10. The carpet according to claim 1, wherein the anti-slip structure forms an anti-slip bottom of the elastic layer or the buffer layer.
